(19) United States
(12) Patent Application Publication
(10) Pub. No.: US 2019/0346882 A1
(43) Pub. Date: Nov. 14, 2019

(54) SYSTEM AND METHOD FOR MOBILE DEVICE INVENTORY CONTROL

(71) Applicant: ADESA, Inc., Carmel, IN (US)

(72) Inventors: Christopher Dillow, Carmel, IN (US); Cody Breeding, Terre Haute, IN (US)

(73) Assignee: ADESA, Inc., Carmel, IN (US)

(21) Appl. No.: 15/975,327

(22) Filed: May 9, 2018

(51) Int. Cl. G06F 1/16; G06F 21/36; E05B 73/00

(52) U.S. Cl. CPC G06F 1/1632; E05B 2073/0088; E05B 73/0082; G06F 21/36

(57) ABSTRACT

A system and method for mobile device inventory control is disclosed. A mobile device is docked and locked in a docking station. When a user wishes to retrieve the mobile device from the docking station, the user may access software, such as an app, on the mobile device that is configured to receive user identification information, such as a user ID. The mobile device transmits the user identification information to an inventory control server, which determines whether to authorize the removal of the mobile device from the docking station. Responsive to the inventory control server authorizing the removal, the mobile device sends a command to the docking station to unlock the docking station. Responsive to the inventory control server denying the removal, the mobile device causes an output to be generated, either on the mobile device or on the docking station, indicating the denial. Thus, the mobile device functionality, including the interface, the communication, the processing, and the memory functionality, may be leverage in order to manage inventory control of the mobile devices.

### BACKGROUND

Mobile devices, such as tablets (e.g., iPads®) or smartphones, may be docked in a docking station. The docking station may then charge a rechargeable battery resident in the mobile device.

### DESCRIPTION OF THE FIGURES

FIG. 1A illustrates a first example of a mobile device inventory control system, which includes mobile devices communicating with both an inventory control server and docking stations.

FIG. 1B illustrates a second example of a mobile device inventory control system, which includes mobile devices communicating with both an inventory control server and docking stations, and which further includes a head unit controlling the docking stations via a bus.

FIG. 1C illustrates a third example of a mobile device inventory control system, which includes mobile devices communicating with both an inventory control server and docking stations, and which further includes a head unit controlling the docking stations via a serial communication connection.

FIG. 2A illustrates a first example of a mobile device inventory control system, which includes mobile devices (in a mobile device cases) communicating with both an inventory control server and docking stations.

FIG. 2B illustrates a second example of a mobile device inventory control system, which includes mobile devices (in a mobile device cases) communicating with both an inventory control server and docking stations, and which further includes a head unit controlling the docking stations via a bus.

FIG. 2C illustrates a third example of a mobile device inventory control system, which includes mobile devices (in a mobile device cases) communicating with both an inventory control server and docking stations, and which further includes a head unit controlling the docking stations via a serial communication connection.

FIG. 3A illustrates a front view of the mobile device case.

FIG. 3B illustrates a front view of the docking station.

FIG. 4A illustrates a flow diagram for a mobile device to interact with the inventory control server in order for a user to remove the mobile device from the docking station.

FIG. 4B illustrates a flow diagram for a mobile device to interact with the inventory control server when a user returns the mobile device to the docking station.

FIG. 5 illustrates a flow diagram for a docking station to interact with the mobile device in order for a user to remove the mobile device from the docking station.

FIG. 6A illustrates a flow diagram for the inventory control server to interact with the mobile device in order for a user to remove the mobile device from the docking station.

FIG. 6B illustrates a flow diagram for the inventory control server to interact with the mobile device when a user returns the mobile device to the docking station.

FIG. 7 illustrates an example of a mobile device inventory control system, which includes docking stations communicating with both an inventory control server and mobile devices.

FIG. 8A illustrates a flow diagram for a mobile device to interact with a docking station in order for a user to remove the mobile device from the docking station.

FIG. 8B illustrates a flow diagram for a mobile device to interact with a docking station when a user returns the mobile device to the docking station.

FIG. 9A illustrates a flow diagram for a docking station to interact with a mobile device in order for a user to remove the mobile device from the docking station.

FIG. 9B illustrates a flow diagram for a docking station to interact with a mobile device when a user returns the mobile device to the docking station.

FIG. 10A illustrates a flow diagram for a server to interact with a docking station in order for a user to remove a mobile device from the docking station.

FIG. 10B illustrates a flow diagram for a server to interact with a docking station when a user returns the mobile device to the docking station.

FIG. 11 illustrates a block diagram of exemplary computer architecture for a device in the exemplary system of FIGS. 1A-2C and 7.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

In various settings, mobile devices, such as Tablet computers, smartphones, laptops, or the like, may be temporarily used. In this context, a mobile device inventory control system may be used to monitor and/or manage the use of the mobile devices, including any one, any combination, or all of: determining whether to allow a user to remove a mobile device from a docking station; determining whether a mobile device has been docked into a docking station; and/or determining the docking station in which a mobile device is docked. In this regard, the system may comprise an inventory control server, the mobile devices, and the docking stations.

In one implementation, the mobile devices may be the interface between the docking stations and the server. In particular, the mobile device may include software (such as an app downloaded from an app server to the mobile device) which is configured to manage the removal of the mobile device from the docking station and manage the return of the mobile device into the docking station.

With regard to managing the removal of the mobile device from the docking station, the mobile device may: receive input from a user in order to input user identification information (e.g., the user's name, the user's credit card information, the user's driver's license number, the user's employee identification number, etc.); send a communication to the inventory control server that includes the user identification information and the mobile device identification information (e.g., a unique code used by the inventory control server to identify the mobile device in the inventory control system); receive a response from the inventory control server indicating whether to allow or disallow removal of the mobile device from the docking station; and responsive to the response indicating allowing removal of the mobile device from the docking station, send a command to the docking station to remove the mobile device from the docking station (e.g., unlock the locking mechanism).

For example, the mobile device may send a request to the inventory control server requesting allowance to remove the mobile device from the docking station. Responsive to the request from the mobile device, the inventory control server determines whether or not to allow the removal of the mobile device, and sends the decision to the mobile device. For example, in response to the inventory control server determining to allow the removal, the inventor control server sends a communication to the mobile device indicating that removal is allowed. Responsive to receiving a communication indicating that removal is allowed, the mobile device may send a command to the docking station to change the state of the locking mechanism from the locked state to the unlocked state, thereby allowing the user to remove the mobile device from the docking station. As another example, response to the inventory control server determining not to allow the removal, the inventor control server sends a communication to the mobile device indicating that removal is not allowed. Responsive to receiving a communication indicating that removal is not allowed, the mobile device does not send a command to the docking station to change the state of the locking mechanism (e.g., maintaining the locking mechanism in the locked state), and may generate an output indicating to the user that the removal of the mobile device from the docking station is denied.

With regard to managing the return of the mobile device to the docking station, the mobile device may: sense the return of the mobile device to the docking station; and responsive to sending the return of the mobile device to the docking station, send to the inventory control server the mobile device identification information and the docking station identification information (e.g., a unique code used by the inventory control server to identify the docking station in the inventory control system).

Thus, in this implementation, the functionality already resident on the mobile device, including the communication functionality, the input/output functionality, and the processing/memory functionality, may be leveraged, thereby reducing the functional requirements of the docking stations. For example, the docking stations need not include wireless functionality (such as to communicate with the inventory control server), may include less processing/memory functionality (since the processing/memory functionality on the mobile device is being leveraged), and may include fewer or no I/O (since the I/O on the mobile device may be used). In this way, the docking station may include: charging functionality configured to charge a battery on the mobile device docked in the docking station (and may charge a battery on a mobile device case which is connected to the mobile device); communication functionality configured to communicate with the mobile device; a locking mechanism; and a controller in communication with the communication functionality and the locking mechanism. The locking mechanism is controllable by the controller to be in a locked state and an unlocked state. In the locked state, the locking mechanism locks the mobile device in the docking station. In the unlocked state, the mobile device is unlocked and removable from the docking station. Further, in one implementation, the charging functionality is configured to charge a battery on the mobile device via a mechanical connector, and the communication functionality is configured to communicate with the mobile device via the same mechanical connector (e.g., via different pins on the same mechanical connector).

In an alternate implementation, the docking stations may be the interface between the mobile devices and the inventory control server. In particular, the docking stations may communicate with the mobile devices and may also communicate with the inventory control server. In practice, the mobile device may include software (such as an app downloaded from an app server to the mobile device) through which the user may enter user identification information. The docking station may then transmit the user identification information (optionally along with the mobile device identification information) to the inventory control server requesting whether to allow the user to remove the mobile device from the docking station.

Responsive to the request from the docking station, the inventory control server determines whether or not to allow the removal of the mobile device, and sends the decision to the docking station. For example, in response to the inventory control server determining to allow the removal, the inventor control server sends a communication to the docking station indicating that removal is allowed. Responsive to receiving a communication indicating that removal is allowed, the controller of the docking station controls the locking mechanism to change its state from the locked state to the unlocked state, thereby allowing the user to remove the mobile device from the docking station. As another example, response to the inventory control server determining not to allow the removal, the inventor control server sends a communication to the docking station indicating that removal is not allowed. Responsive to receiving a communication indicating that removal is not allowed, the controller of the docking station does not change the state of the locking mechanism (e.g., maintaining the locking mechanism in the locked state), and generates an output indicating to the user that the removal of the mobile device from the docking station is denied.

Further, the user may return a mobile device to a docking station. In practice, the docking station may receive an indication that the mobile device has been docked into the docking station. In particular, the docking station may sense the return of the mobile device by sensing a USB connection with the mobile device docked therein. Responsive to receiving the indication, the docking station may: communicate with the mobile device in order to receive a mobile device identification; transmit a docking request to the inventory control server, with the docking request comprising the mobile device identification and indicative to the server that the mobile device has been docked into the docking station; and activate the docking clamp so that the docking station is in the locked state.

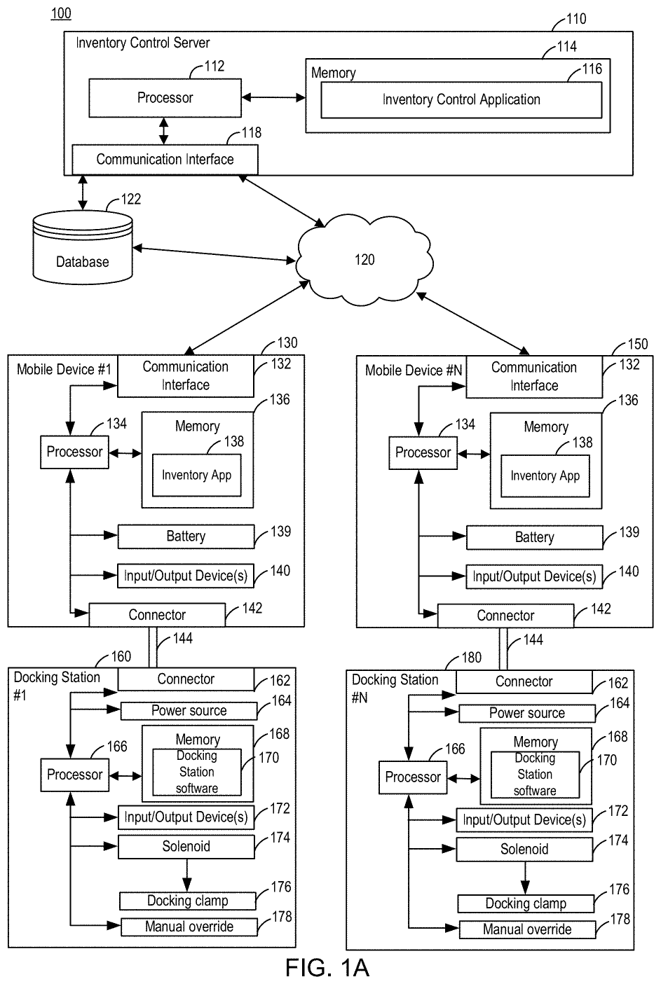

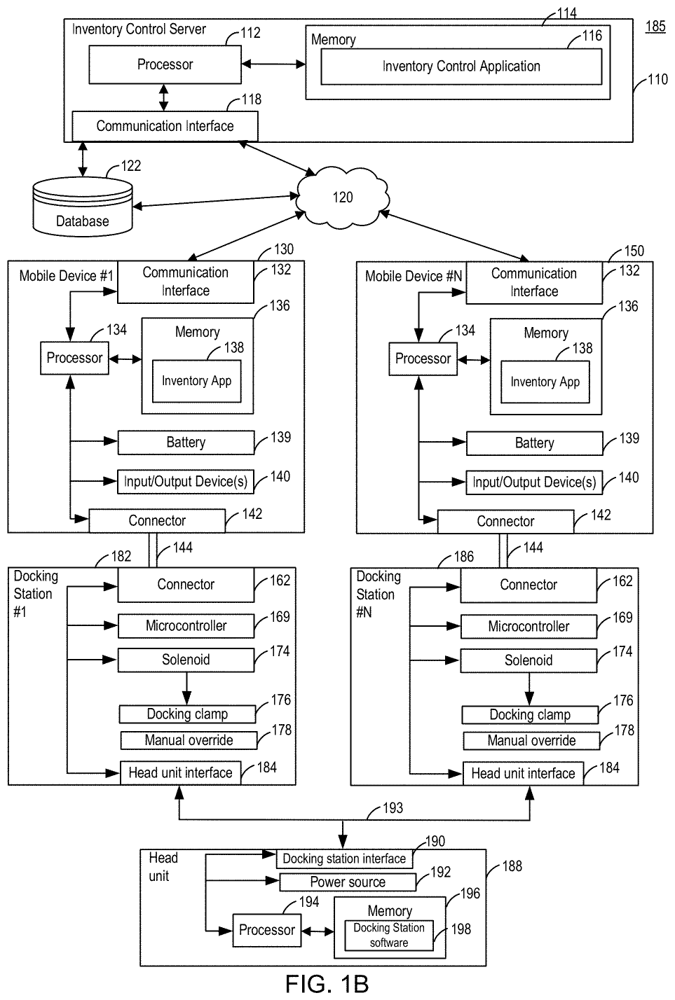

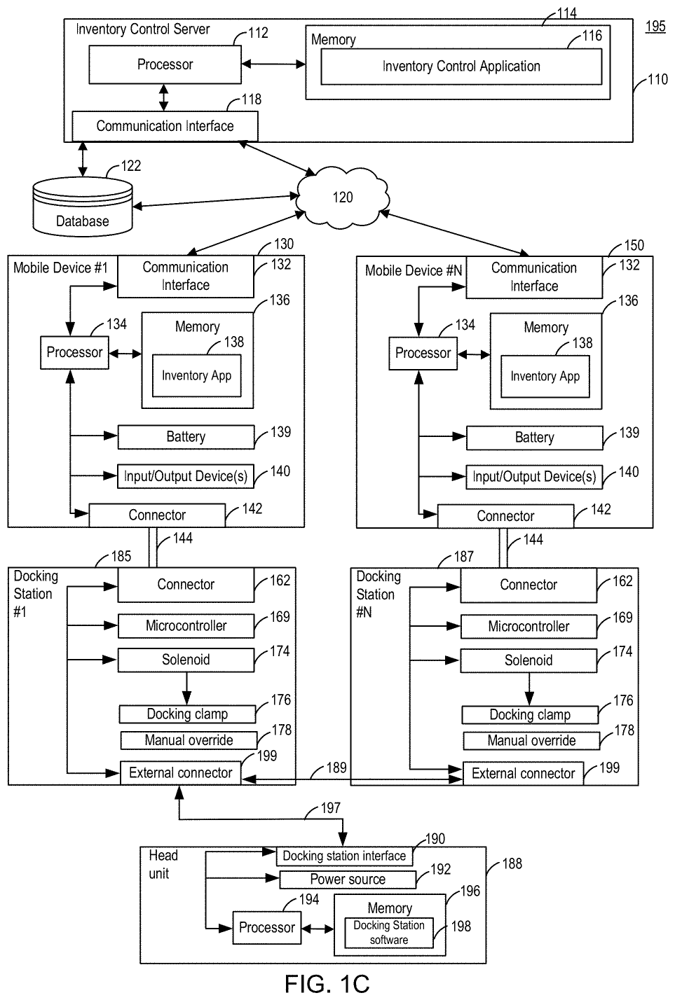

Referring to the figures, FIG. 1A illustrates a first example of a mobile device inventory control system 100, which includes mobile devices (mobile device #1 (130), mobile device #N (150)) communicating with both an inventory control server 110 and docking stations (docking station #1 (160), docking station #N (180)).

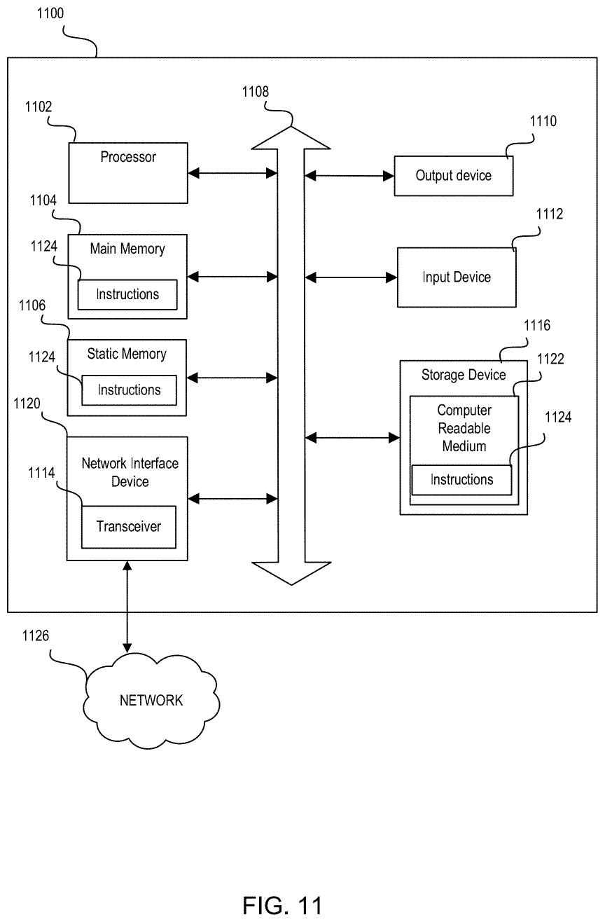

Inventory control server 110 is configured to include the hardware, software, firmware, and/or middleware for operating the inventory control application 116. Inventory control server 110 is shown to include a processor 112, a memory 114, and a communication interface 118. As discussed below with regard to FIG. 11, various types of processors and memories are contemplated. The inventory control application 116 is described in terms of functionality to monitor the inventory of mobile devices, such as mobile device #1 (130) to mobile device #N (150). Though inventory control application 116 is illustrated as resident in memory 114, inventory control application 116 may be a representation of software, hardware, firmware, and/or middleware configured to implement monitoring of the mobile devices.

The mobile device inventory control system 100 may further include a database 122 for storing data for use by the inventory control application 116. For example, data directed to which persons have withdrawn mobile device and/or which docking stations include mobile devices may be stored in database 122.

The inventory control server 110 may communicate with the database 122 directly to access the data. Alternatively, the inventory control server 110 may also communicate with the database 122 via network 120 (e.g., the Internet). Though FIG. 1A illustrates direct and indirect communication, in one implementation, only direct communication is used, in an alternate implementation, only indirect communication is used, and still in an alternate implementation, both direct and indirect communication is used.

The inventory control server 110 may communicate with any number and type of communication devices via network 120. For example, inventory control server 110 may communicate with one or more mobile devices, such as mobile device #1 (130) to mobile device #N (150). In turn, a mobile device may communicate with the respective docking station in which it is docked (e.g., mobile device #1 (130) communicating with docking station #1 (160) and mobile device #N (150) communicating with docking station #N (180)). The depiction in FIG. 1A is merely for illustration purposes. Fewer or greater numbers of docking stations and/or mobile devices are contemplated. Further, the docking stations, such as docking station #1 (160) to docking station #N (180), may be modular in design. Thus, in practice, the docking stations may be positioned in a rack, with at least a predetermined number of docking stations (e.g., 5 or 10) in the rack, as discussed further below.

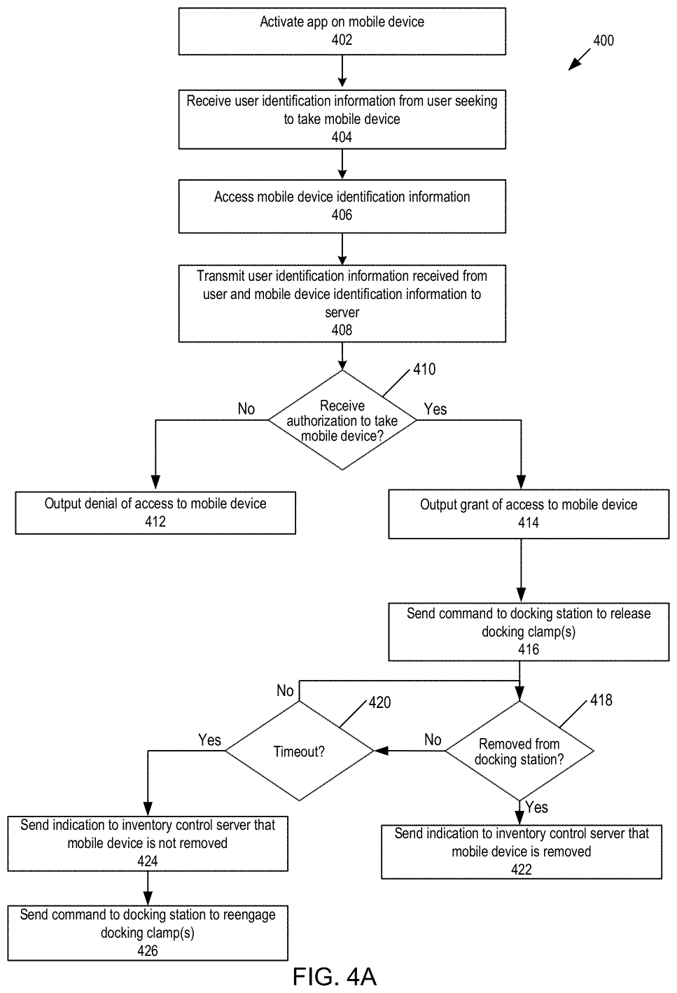

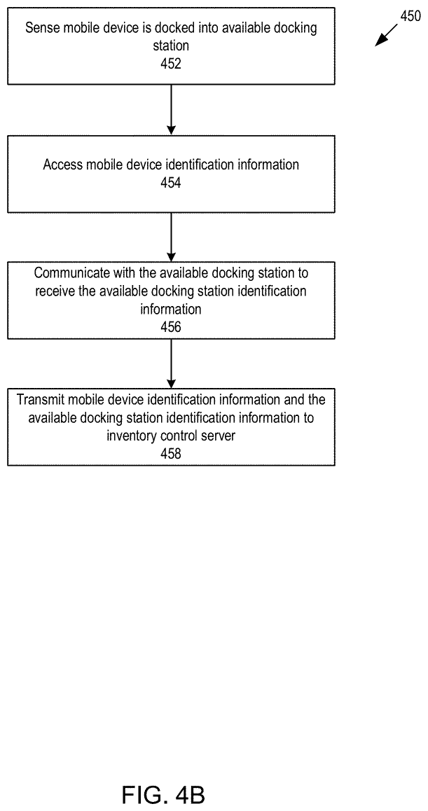

Mobile device #1 (130) includes communication interface 132, processor 134, memory 136, battery 139, input/output device(s) 140, and connector 142. Communication interface 132 may comprise a wireless communication interface configured to communicate wirelessly, such as cellular, Wi-Fi, Bluetooth, or the like. In this regard, communication interface 132 may include one or more wireless transceivers configured to communicate via one or more wireless protocols, such as discussed in further detail below. Memory 136 may include software, such as inventory app 138. Memory may also be configured to store various identification information, such as mobile device identification information. The memory 136 illustrated may comprise a single memory or may comprise multiple memories (such as multiple types of memories). As discussed further below with regard to FIGS. 4A-B, the mobile device may manage the interaction with the inventory control server 110 and the docking station 160 using inventory app 138. Battery 139 may comprise a rechargeable battery that may be charged via power source 164 on docking station #1 (160). Input/output device(s) 140 may comprise any type of input and/or output device, such as a display (e.g., a touchscreen display), a speaker, a keyboard, or the like. Input/output device(s) 140 is an example of an input interface through which the user identification information may be input. Connector 142 may be shaped to mechanically connect with connector 162 of docking station #1 (160) via connection 144. As discussed in further detail below, a user may access inventory app 138 via input/output device(s) 140 in order for the user to input user identification information for submission to mobile device #1 (130). In one implementation, the inventory app 138 may automatically activate to output an interface on a screen of mobile device #1 (130) upon wake-up of mobile device #1 (130). Alternatively, the user may activate inventory app 138. After activation, the user may input user identification information. As discussed above, the user identification information may comprise the user's name, the user's credit card information, the user's driver's license number, the user's employee identification number, or other information indicative of or unique to the user.

Docking station #1 (160) may include a connector 162, power source 164, a processor 166, a memory 168, input/output device(s) 172, solenoid 174, docking clamp 176 (or other type of locking mechanism), and manual override 178. As discussed above, because the mobile device functionality is leveraged, the functionality on the docking station may be reduced. In this regard, the processor 166 and memory 168 may have reduced capability. For example, the processor 166 and memory 168 may be manifested in a microcontroller. In particular, the microcontroller may be configured for limited functionality, such as solely configured to activate/deactivate solenoid 174 responsive to a command from mobile device #1 (130) (e.g., a first signal sent from the mobile device via the USB connection with the docking station is indicative to the docking station to activate the solenoid, and a second signal from the mobile device via the USB connection with the docking station is indicative to the docking station to deactivate the solenoid). Further, the input/output device(s) 172 on docking station #1 (160) may be removed, instead relying on the input/output device(s) 140 on mobile device #1 (130).

Connector 162, which may comprise a mechanical connector, may be the means through which docking station #1 (160) communicates with mobile device #1 (130). In addition, connector 162 may be the means through which docking station #1 (160) recharges, using power source 164, the battery 139 resident in mobile device #1 (130).

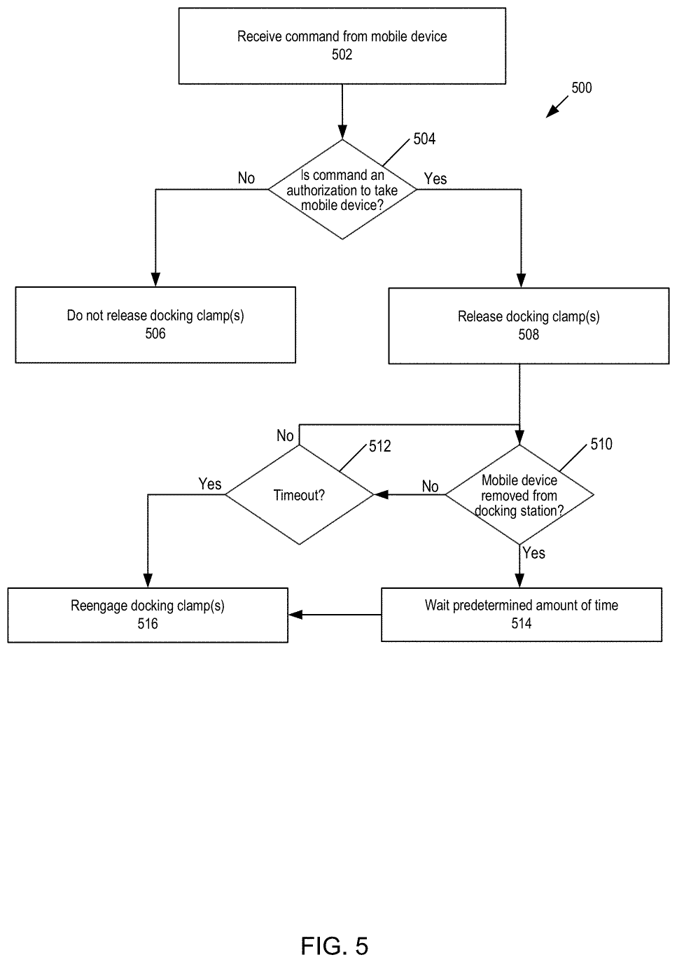

Memory 168 includes docking station software 170, which may comprise functionality such as illustrated in FIG. 5. Input/output device(s) 172 may comprises any type of input and/or output device, such as a visual output (e.g., a display or an LED light), an aural output (e.g., a speaker) or the like. As discussed further below, the docking station may generate an output via input/output device(s) 172 in response to denying and/or granting removal of the mobile device from the docking station. Further, the docking station may generate an output via input/output device(s) 172 in response to the mobile device being docked into the docking station. Alternatively, the outputs may be generated via input/output device(s) 140 on mobile device #1 (130), as discussed above.

Docking clamp 176 may comprise any type of locking mechanism that locks or restrains a mobile device within the respective docking station. Further, the respective docking station may include a single docking clamp or multiple docking clamps. In practice, the processor 166 may control the docking clamp 176, such as via solenoid 174, to be in one of two states: locked (in which the mobile device is locked or restrained within the docking station so that a user cannot remove the mobile device from the docking station); and unlocked (in which the mobile device is unrestrained within the docking station so that a user can remove the mobile device from the docking station). In this way, the solenoid 174 may change the state of the docking clamp 176. Alternatively, other types of mechanical or electrical devices are contemplated to change the state of docking clamp 176. Docking station #1 (160) may further include manual override 178. In instances with one or both of docking station #1 (160) or mobile device #1 (130) are not functional (e.g., lack of power to one or both of docking station #1 (160) or mobile device #1 (130)), manual override 178 may comprise an input in order to manually release docking clamp 176. In one form, manual override 178 may include a keyslot in which a key may be inserted and turned. Upon turning the key in the keyslot, the docking clamp 176 may be released.

FIG. 1B illustrates a second example of a mobile device inventory control system 185, which includes mobile devices (mobile device #1 (130), mobile device #N (150)) communicating with both an inventory control server 110 and docking stations (docking station #1 (182), docking station #N (186)), and which further includes a head unit 188 controlling the docking stations (docking station #1 (182), docking station #N (186)) via a bus 193. Bus 193 may comprise parallel or serial connections. For example, bus 193 may comprise individual line connections between head unit 188 and the respective docking station. As another example, bus 193 may comprise common line connections between head unit 188 and the docking stations.

Head unit 188 includes a docking station interface 190, a power source 192, a processor 194, and a memory 196. As illustrated, the docking stations, including docking station #1 (182), docking station #N (186), include less functionality, including no processing, memory, or power functionality. Instead, head unit 188 supplies these functionalities to the docking stations. Memory 196 includes docking station software 198, which is configured to control a plurality of docking stations, such as docking station #1 (182) and docking station #N (186).

Docking station #1 (182) and docking station #N (186) further include microcontroller 169 and head unit interface 184 (such as a connector), which may be used to communicate with head unit 188 via bus 193. Specifically, microcontroller 169 may be configured for limited functionality, such as solely configured to activate/deactivate solenoid 174 responsive to a command from head unit 188 (e.g., a first signal from the head unit is indicative to the docking station to activate the solenoid, and a second signal from the head unit is indicative to the docking station to deactivate the solenoid). In practice, communications from the respective mobile device, such as mobile device #1 (130) via connector 162 of docking station #1 (160), may be routed to head unit via bus 193. In response, head unit 188, using processor 194 and docking station software 198, may send a command to docking station #1 (160), such as to activate solenoid 174 to release docking clamp 176.

FIG. 1C illustrates a third example of a mobile device inventory control system, which includes mobile devices (mobile device #1 (130), mobile device #N (150)) communicating with both an inventory control server 110 and docking stations (docking station #1 (185), docking station #N (187)), and which further includes a head unit 188 controlling the docking stations (docking station #1 (185), docking station #N (187)) via a serial communication connection 189, 197. Specifically, the configuration for communications from the head unit 188 to the docking stations may be daisy chained so that a communication may first be sent via serial communication connection 197 to external connector 199 of docking station #1 (185), and thereafter routed to docking station #N (187) via serial communication connection 189.

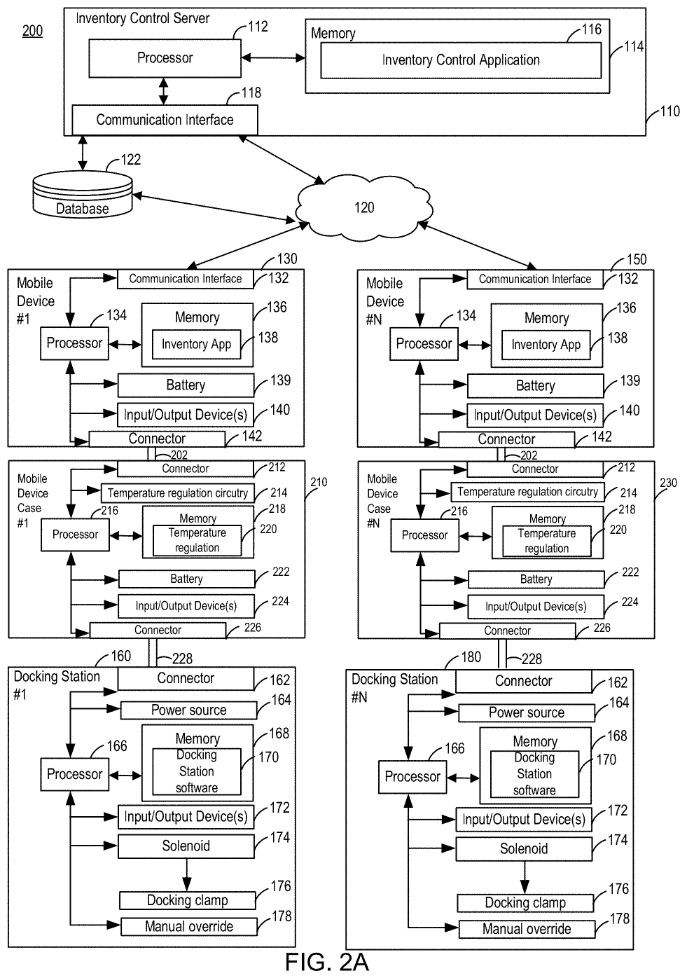

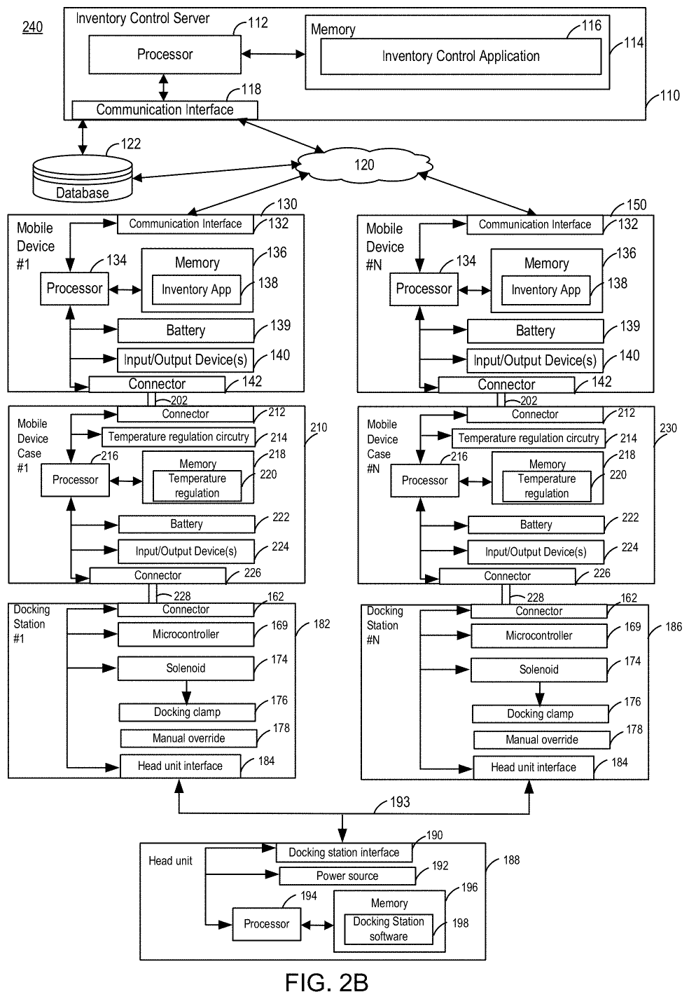

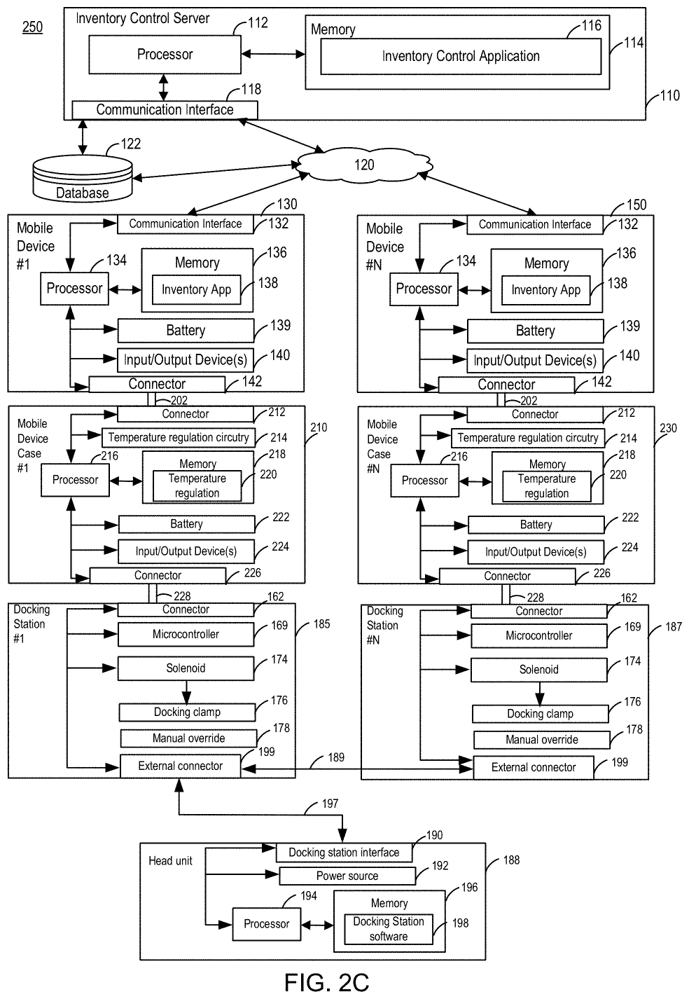

FIG. 2A illustrates a first example of a mobile device inventory control system 200, which includes mobile devices (mobile device #1 (130), mobile device #N (150)) in respective mobile device cases (mobile device case #1 (210), mobile device case #N (212) communicating with both an inventory control server 110 and docking stations (docking station #1 (160), docking station #N (180)).

The mobile device case may perform one or more functions, such as any one, any combination, or all of: supplying power to the respective mobile device; regulating the temperature of the mobile device; or mechanically protecting the mobile device. For example, mobile device case #1 includes connector 212, temperature regulation circuitry 214, processor 216, memory 218, battery 222, input/output device(s) 224, and connector 226. Connector 212 may connect to mobile device #1 (130) via connection 202. For example, the connection 202 may comprise a wired connection.

Memory 218 may include one or more software programs, such as temperature regulation software 220, which may work in combination with temperature regulation circuitry 214, in order to regulate the temperature of mobile device #1 (130). Discussion of the mobile device case is in U.S. application Ser. No. ______ entitled “Mobile Device Temperature-Regulating Case”, attorney docket no. 015535-18106A-US, which is incorporated by reference herein in its entirety.

When undocked, battery 222 in mobile device case #1 (210) may supply power to mobile device #1 (130), including charging battery 139 resident in mobile device #1 (130). When docked, power source 164 on docking station #1 (160) may charge both battery 222 in mobile device case (210) and battery 139 in mobile device #1 (130). Mobile device case #1 (210) may further include input/output device(s) 224, such as visual or auditory outputs. Mobile device case #1 (210) may further include connector 226 which may connect via connection 228 with docking station #1 (160). In this way, mobile device may be contained or within a respective mobile device case, with the combination of mobile device and mobile device case being docked in the respective docking station. Further, in one implementation, the docking clamp 176 or other locking mechanism may connect or attach to a part of the mobile device case in order to hold or secure the mobile device/mobile device case combination within the respective docking station. Manual override 178 may enable the manual release of the mobile device/mobile device case combination from the respective docking station. Thus, the configuration and operation of FIG. 2A is similar to the configuration and operation of FIG. 1A, with the addition of the mobile device case. As one example, the processor 166 and memory 168 may comprise a microcontroller with limited functionality, such as solely configured to control activation/deactivation of solenoid 174, as discussed with regard to FIG. 1A.

FIG. 2B illustrates a second example of a mobile device inventory control system 240, which includes mobile devices (mobile device #1 (130), mobile device #N (150)) in respective mobile device cases (mobile device case #1 (210), mobile device case #N (212) communicating with both an inventory control server 110 and docking stations (docking station #1 (182), docking station #N (186)), and which further includes a head unit 188 controlling the docking stations (docking station #1 (182), docking station #N (186)) via a bus 193. Thus, the configuration and operation of FIG. 2B is similar to the configuration and operation of FIG. 1B, with the addition of the mobile device case.

FIG. 2C illustrates a third example of a mobile device inventory control system 250, which includes mobile devices (mobile device #1 (130), mobile device #N (150)) in respective mobile device cases (mobile device case #1 (210), mobile device case #N (212) communicating with both an inventory control server 110 and docking stations (docking station #1 (185), docking station #N (187)), and which further includes a head unit 188 controlling the docking stations (docking station #1 (185), docking station #N (187)) via a serial communication connection 189, 197. Thus, the configuration and operation of FIG. 2C is similar to the configuration and operation of FIG. 1C, with the addition of the mobile device case.

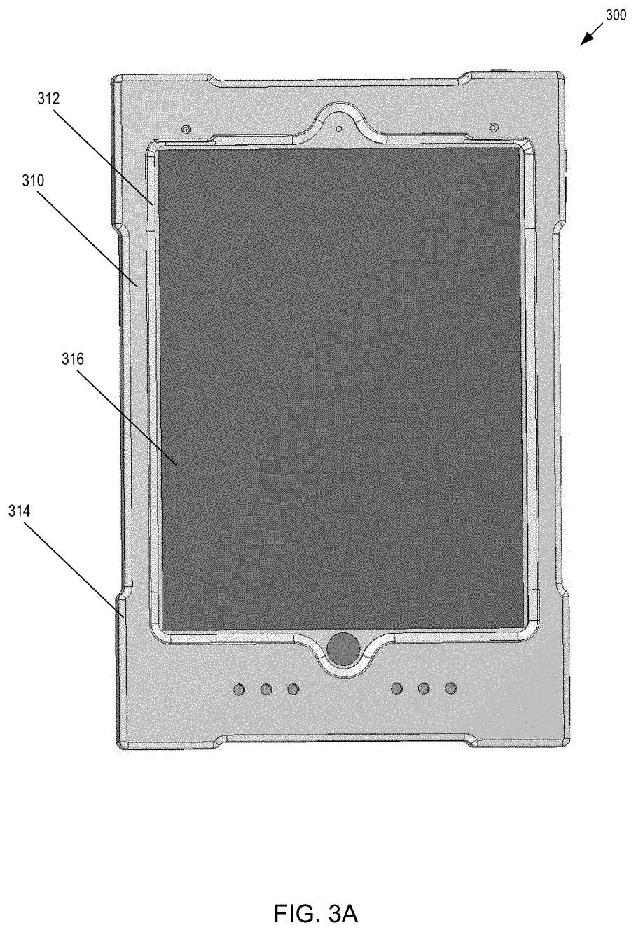

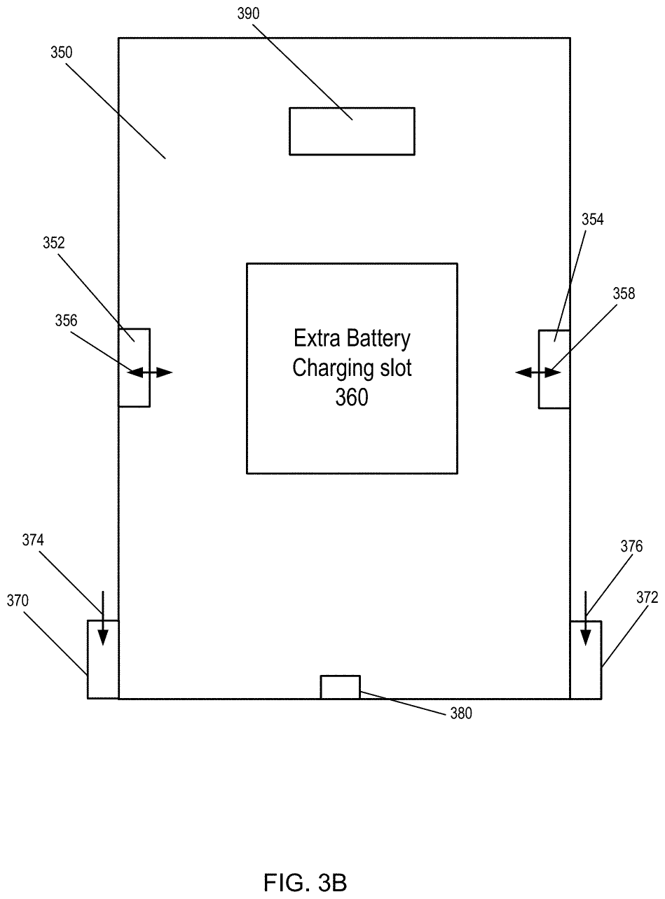

FIG. 3A illustrates a front view of the mobile device case 300. The mobile device case 300 may be connected to the mobile device in one of several ways. In one way, the mobile device may be pressed fit into the mobile device case 300 may be pressed-fit. Alternatively, or in addition, the mobile device case 300 may be screwed or bolted to the mobile device. The mobile device case 300 includes a front portion 310, an inner ridge 312 and corner members 314. The inner ridge 312 may travel along the entire perimeter of screen 316 of mobile device. Alternatively, the inner ridge 312 may travel along less than the entire perimeter of screen 316 of mobile device. Further, corner members 314 may be positioned at each of the 4 corners, such as illustrated in FIG. 3A. Alternatively, corner members 314 may be positioned at less than all of the 4 corners. The inner ridge 312 may be composed of rubber, whereas other sections, such as front portion 310, and back portion (not shown), may be composed of a more rigid structure, such as injection-molded plastic. Locking mechanism may attach to one or more parts of mobile device case 300. For example, a clamp may clamp to one or more of corner members 314 of mobile device case 300.

FIG. 3B illustrates a front view of the docking station. Specifically, docking station may include a base 350 in which mobile device case/mobile device may be seated. Docking station may further include one or more locking mechanisms 352, 354 that may engage with one or more sections of the mobile device case, such as mobile device case 300. In one example, the one or more locking mechanisms 352, 354 may comprise movable bolts that are positioned at a 45° angle and move in directions as shown by arrows 356, 358. In operation, pushing mobile device case 300 into base 350 causes locking mechanisms 352, 354 to retract (e.g., move toward the edge of the base 350) so that mobile device case 300 may be seated into base 350. When the mobile device case 300 is pushed past locking mechanisms 352, 354 and seated into base 350, locking mechanisms 352, 354, which may be spring-loaded, may extend (such as illustrated in FIG. 3B), thereby preventing mobile device case 300 from being removed. Specifically, a periphery of mobile device case 300, such as front portion 310, inner ridge 312, or corner members 314, may catch against locking mechanisms 352, 354. Thus, in one implementation, locking mechanisms 352, 354 may comprise toggle latches and a part of the mobile device case may act as a strike plate. Further, when mobile device case/mobile device are seated in the base, a back of the mobile device case/mobile device face the base 350, and a display of the mobile device faces outward. In this way, a user may access the display of the mobile device when interacting with the app on the mobile device. Further, the locking mechanism illustrated in FIG. 3B is merely for illustration purposes. Other locking mechanisms are contemplated.

Base 350 may further include extra battery charging slot 360. Extra battery charging slot 360 may be configured to receive a rechargeable battery therein. In this way, separate from recharging the battery on the mobile device, such as battery 139, and recharging the battery on the mobile device case, such as battery 222, an extra battery may be recharged as well. After removal of the mobile device and mobile device case, the extra battery may replace battery 222 in mobile device case. Because the battery, when seated in extra battery charging slot 360, is in base 350 and abuts a backside of the mobile device case, the extra battery is only accessible when the mobile device/mobile device case is removed from docking station. In this way, the user may take the extra battery along with the extra battery charging slot 360. Thus, in one implementation, the docking station includes the extra battery charging slot 360. Alternatively, the docking station does not include any functionality for extra battery charging (including no extra battery charging slot 360).

Docking station may further be configured for connection with another device, such as another docking station or a head unit (such as head unit 188). To that end, one or more sides of the docking station may include connectors 370, 372. The connectors may mate with one another, such as connector 370 mating with connector 372. In this way, the docking stations may be ganged together. Examples of connectors 370, 372 may comprise dovetail connectors in which the connectors are slid into one another as shown by arrows 374, 376. Separate from connecting the docking stations via connectors 370, 372, the docking station may be affixed via screw 380, such as affixing docking station to a platform. Alternatively, the docking station may be affixed to the wall via a screw through base 350. Using the two ways of connection, the docking station is affixed in multiple dimensions. In addition, the docking station may be affixed to the platform or wall such that when the mobile device case/mobile device is inserted, the display of the mobile device faces a user standing in front of the docking station.

Further, base 350 may include a connector 390, such as a USB connector. In practice, when the mobile device is seated into base 350, a connector, such as a USB connector, engages with connector 390. In this way, after being seated, the mobile device may recognize, via the USB connection, that the mobile device is seated in the docking station.

As discussed above, in one implementation, the mobile device is configured to communicate both with the docking station and with the inventory control server. FIG. 4A illustrates one example of this communication both with the docking station and with the inventory control server, with flow diagram 400 illustrating interaction with the inventory control server in order for a user to remove the mobile device from the docking station. At 402, the app is activated on the mobile device. The app may be activated automatically, such as upon wake-up of the mobile device when docked in the docking station. Alternatively, the app may be activated by the user specifically executing the app (e.g., touching the icon associated with the app on the display of the mobile device). At 404, the mobile device receives user identification information from the user seeking to take the mobile device. As discussed above, various types of user identification information are contemplated. For example, the mobile device may generate a GUI on the display requesting user input. As another example, the user may swipe a credit card via a credit card reader that is plugged into a USB port on the mobile device in order to input user identification information.

At 406, the mobile device accesses mobile device identification information. As discussed above, various types of mobile device identification information are contemplated. At 408, the mobile device transmits the user identification information and the mobile device identification information. The transmission may comprise a request communication to the inventory control server, with the request communication including the user identification information and the mobile device identification information. The request communication may comprise a single transmission, which includes both the user identification information and the mobile device identification information. Alternatively, the request communication may comprise separate transmissions, with one transmission including the user identification information and another transmission including the mobile device identification information. At 410, the mobile device determines whether it has received an authorization for the user to take the mobile device. For example, the inventory control server may send a communication, which may comprise a response to the request communication from the mobile device, that includes a field that includes a code, with the code indicating authorization or denial of access. The mobile device may access the field in the communication and compare the code in the field with a predetermined authorization code. If the field in the communication matches the predetermined authorization code, the mobile device may determine that the user is authorized. If the field in the communication does not match the predetermined authorization code, the mobile device may determine that the user is not authorized.

Responsive to the mobile device determining that the user is not authorized, the mobile device may cause an output to be generated (such as at the mobile device and/or at the docking station) indicating the denial of access. For example, at 412, the mobile device may output an indication of denial of access. Various indications of denial of access are contemplated. For example, the output may comprise an aural output. As another example, the output may comprise a visual output, such as outputting “DENIED” on the screen of the mobile device. Similarly, responsive to the mobile device determining that the user is authorized, the mobile device may cause an output to be generated (such as at the mobile device and/or at the docking station) indicating the authorization of access. For example, at 414, the mobile device may output an indication of authorization of access. Various indications of authorization of access are contemplated. For example, the output may comprise an aural output (which may be different from the aural output for a denial). As another example, the output may comprise a visual output, such as outputting “AUTHORIZED” on the screen of the mobile device. Further, at 416, the mobile device may send a command, such as a release command, to the docking station to release the docking clamp(s). In particular, the release command may be indicative to the docking station to release the docking clamp(s).

At 418, the mobile device determines whether the mobile device has been removed from the docking station. As discussed above, the mobile device may determine whether it has been removed based on the USB interface. If the mobile device determines that it has not been removed, at 420, the mobile device determines whether the timeout has occurred. For example, the mobile device may wait 1 minute until determining a timeout has occurred. Other timeout periods, greater than or less than 1 minute, are contemplated. If not, flow diagram 400 loops back to 418. If yes, at 424, the mobile device may send an indication, such as a failure to remove mobile device communication, to the inventory control server that the mobile device has not been removed. In particular, the failure to remove mobile device communication may be indicative to the inventory control server that the mobile device was not removed from the docking station. Further, at 426, the mobile device may send a command to the docking station to change the state of the docking clamp (e.g., reengage the docking clamp). If the mobile device determines that it has been removed from the docking station, at 422, the mobile device may send an indication, such as a removed mobile device communication, to the inventory control server that the mobile device has been removed. In particular, the removed mobile device communication may be indicative to the inventory control server that the mobile device was removed from the docking station.

FIG. 4B illustrates a flow diagram 450 for a mobile device to interact with the inventory control server when a user returns the mobile device to an available docking station. The available docking station may be the same docking station as the docking station that the mobile device was removed from. Alternatively, the available docking station may be a different docking station as the docking station that the mobile device was removed from. At 452, the mobile device senses that it is docked in the available docking station. As discussed above, the mobile device may determine whether the mobile device has a USB connection with the available docking station to determine whether the mobile device is docked. At 454, the mobile device may access the mobile device identification information. At 456, the mobile device may communicate with the available docking station in order to receive from the available docking station the available docking station identification information. At 458, the mobile device may transmit a communication, such as a redocked communication, that includes the mobile device identification information and the available docking station identification information to the inventory control server. In particular, the redocked communication may be indicative to the inventory control server that the mobile device has been redocked.

FIG. 5 illustrates a flow diagram 500 for a docking station to interact with the mobile device in order for a user to remove the mobile device from the docking station. At 502, the docking station receives a command from the mobile device. At 504, the docking station determines whether the command indications authorization to take the mobile device. If not, at 506, the docking station does not change the state of the docking clamp(s) and rejects the request to remove the mobile device.

If so, at 508, the docking station releases the docking clamp(s), such as by activating the solenoid. At 510, the docking station then monitors whether the mobile device has been removed from the docking station. The docking station may make this determination based on the USB interface with the mobile device. If not, at 512, the docking station determines whether the timeout has occurred. For example, the docking station may wait 1 minute until determining a timeout has occurred. If not, flow diagram 500 loops back to 510. If timeout has occurred, at 516, the docking station reengages the docking clamp(s) in order to lock the mobile device in the docking station. Alternatively, the mobile device may determine whether the timeout has occurred, and in response to the determination, send a command to the docking station to reengage the docking clamp(s).

If the docking station determines that the mobile device has been removed from the docking station, at 514, the docking station waits a predetermined amount of time (e.g., 5 seconds or 10 seconds) and at 516, reengages the docking clamp(s) in preparation to receive another mobile device in the docking station.

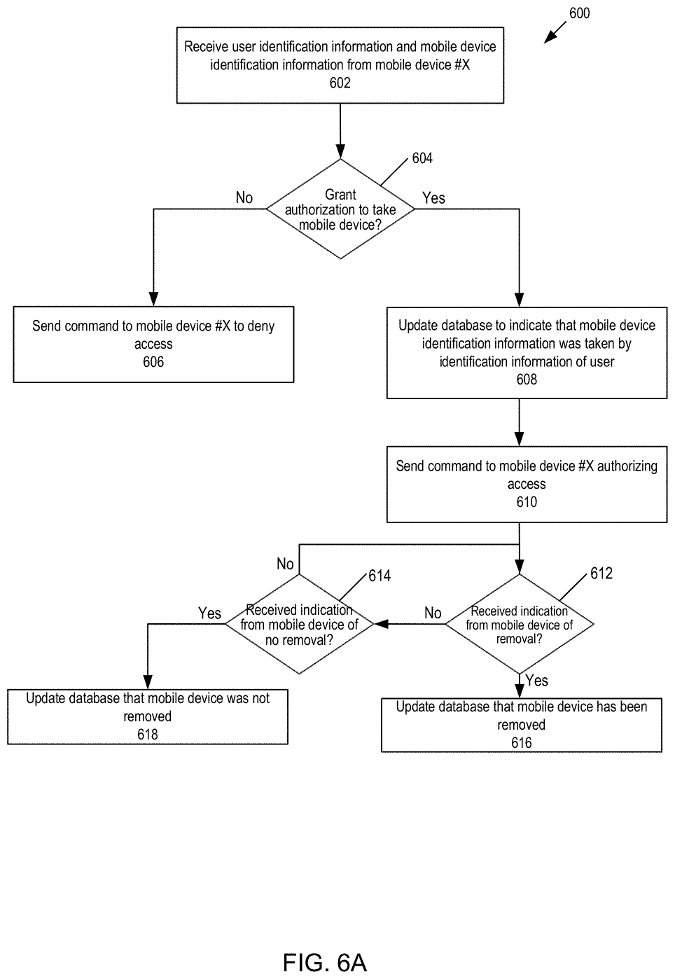

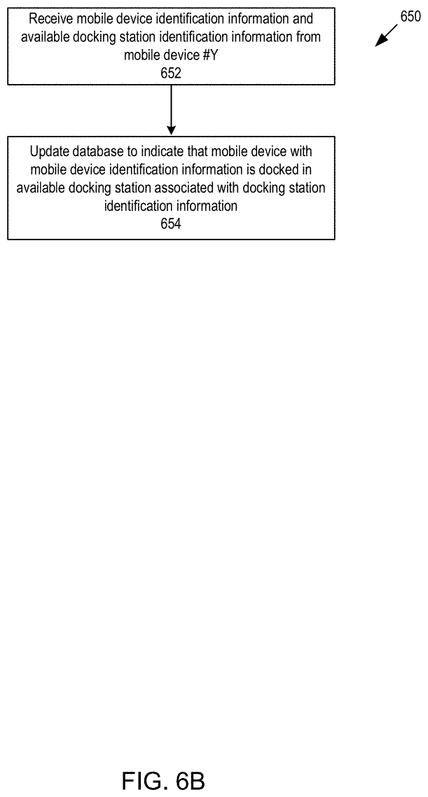

FIG. 6A illustrates a flow diagram 600 for the inventory control server to interact with the mobile device in order for a user to remove the mobile device from the docking station. At 602, the inventory control server receives user identification information and mobile device identification information from a mobile device, such as mobile device #X. At 604, the inventory control server determines whether to grant authorization to take the mobile device. The inventory control server may review one or both of the user identification information or the mobile device identification information in determining whether to grant authorization. For example, the inventory control server may determine whether the user identification information is indicative of an employee of the company, and if so, grant removal of a company mobile device. As another example, the inventory control server may determine whether the user identification information, which comprises credit card information, is valid, and if so, grant removal of the mobile device. Thus, in response to determining not to authorize the taking of the mobile device, at 606, the inventory control server sends a communication, such as a deny communication, to the mobile device to deny access. In particular, the deny communication may be indicative to the mobile device to cause an output representative of denying removal of the mobile device from the docking station. In response to determining to authorize the taking of the mobile device, at 608, the inventory control server sends a communication, such as an authorize communication, to the mobile device to deny access. In particular, the authorize communication may be indicative to the mobile device to command the docking station to change a state of the docking station to allow removal of the mobile device from the docking station.

At 610, the inventory control server sends a command to the mobile device, such as mobile device #X, authorizing access. At 612, the inventory control server determines whether it has received an indication from the mobile device that the mobile device has been removed from the docking station. If not, at 614, the inventory control server further checks to determine whether the inventory control server has received an indication from the mobile device that the mobile device has not been removed. If yes, at 618, the inventory control server may update the database to indicate that the mobile device was not removed. This indication may be in two forms. In one form, the inventory control server may leave the entry in the database unchanged (e.g., the mobile device #X is still docked at docking station #Y). In another form, the inventory control server may indicate that the mobile device was temporarily checked out and then redocked (e.g., the mobile device #X is was temporarily removed from docking station #Y and then redocked at docking station #Y).

If the inventory control server determines that it has not received an indication from the mobile device of no removal, flow diagram 600 loops back to 612. If at 612, the inventory control server determines that it has received indication from the mobile device that the mobile device was removed from the docking station, at 616, the inventory control server updates the database to indicate that the mobile device has been removed from the docking station. The indication may include the time of removal (such as indicated by the mobile device communication to the inventory control server) and/or the user identification information.

FIG. 6B illustrates a flow diagram 650 for the inventory control server to interact with the mobile device when a user returns the mobile device to the docking station. At 652, the inventory control server receives a communication from the mobile device, with the communication including mobile device identification information (e.g., to identify the mobile device that sent the communication) and available docking station identification information (indicating the available docking station in which the mobile device that send the communication is docked). One example of the communication is a docking request, which is received from the mobile device that is docked in the available docking station, the docking request comprising mobile device identification information and available docking station identification information. At 654, responsive to the communication, the inventory control server updates the database to indicate that the mobile device associated with the mobile device identification information is docked in the available docking station associated with the available docking station identification information. Optionally, the inventory control server may determining a time period between removal and return of the mobile device associated with the mobile device identification information. For example, the inventory control server may calculate a number of minutes, hours, days, or the like between removal and return of the mobile device. Responsive to the calculation of the time period, the inventory control server may charge or associate a fee with the user identification information (e.g., the user who removed and returned the mobile device) based on the time period. For example, the inventory control server may charge a fee per hour for the time period calculated.

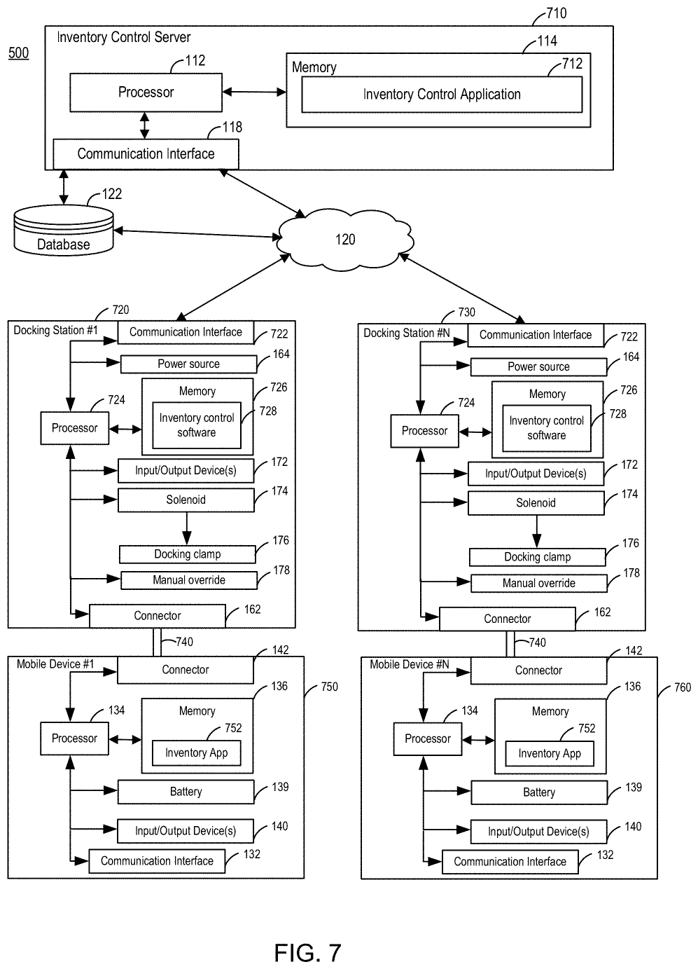

FIG. 7 illustrates an example of a mobile device inventory control system 700, which includes docking stations (docking station #1 (720), docking station #N (730)) communicating with both an inventory control server 710 and mobile devices (mobile device # (750), mobile device #N (760)). The mobile device inventory control system 700 includes an inventory control server 710 configured to include the hardware, software, firmware, and/or middleware for operating the inventory control application 712. Similar to FIGS. 1A-2C, inventory control server 710 is shown to include a processor 112, a memory 114, and a communication interface 118. The inventory control application 712 is described in terms of functionality to monitor the inventory of mobile devices, such as mobile device #1 (750) to mobile device #N (760). Though inventory control application 712 is illustrated as resident in memory 114, inventory control application 712 may be a representation of software, hardware, firmware, and/or middleware configured to implement monitoring of the mobile devices.

Similar to FIGS. 1A-2C, the mobile device inventory control system 700 may further include a database 122 for storing data, such as inventory data, for use by the inventory control application 712. For example, data directed to which persons have withdrawn mobile device and/or which docking stations include mobile devices may be stored in database 122.

The inventory control server 710 may communicate with any number and type of communication devices via network 120. For example, inventory control server 710 may communicate with one or more docking stations, such as docking station #1 (720) to docking station #N (730). The depiction in FIG. 7 is merely for illustration purposes. Fewer or greater numbers of docking stations and/or mobile devices are contemplated. Further, the docking stations, such as docking station #1 (720) to docking station #N (730), may be modular in design, as discussed above. Thus, in practice, the docking stations may be positioned in a rack, with at least a predetermined number of docking stations (e.g., 10) in the rack.

Docking station #1 (720) includes a communication interface 722, a power source 164, a processor 734, a memory 736, input/output device(s) 172, solenoid 174, docking clamp 176, and connector 162. Unlike the docking station illustrated in FIGS. 1A-2C, the communication interface 1032 is configured to communicate, via network 120, with inventory control server 710. Further, similar to FIGS. 1A-2C, connector 162, which may comprise a mechanical connector, may be the means through which docking station #1 (720) communicates with mobile device #1 (750). In addition, connector 162 may be the means through which docking station #1 (720) recharges, using power source 164, the battery 139 resident in mobile device #1 (750).

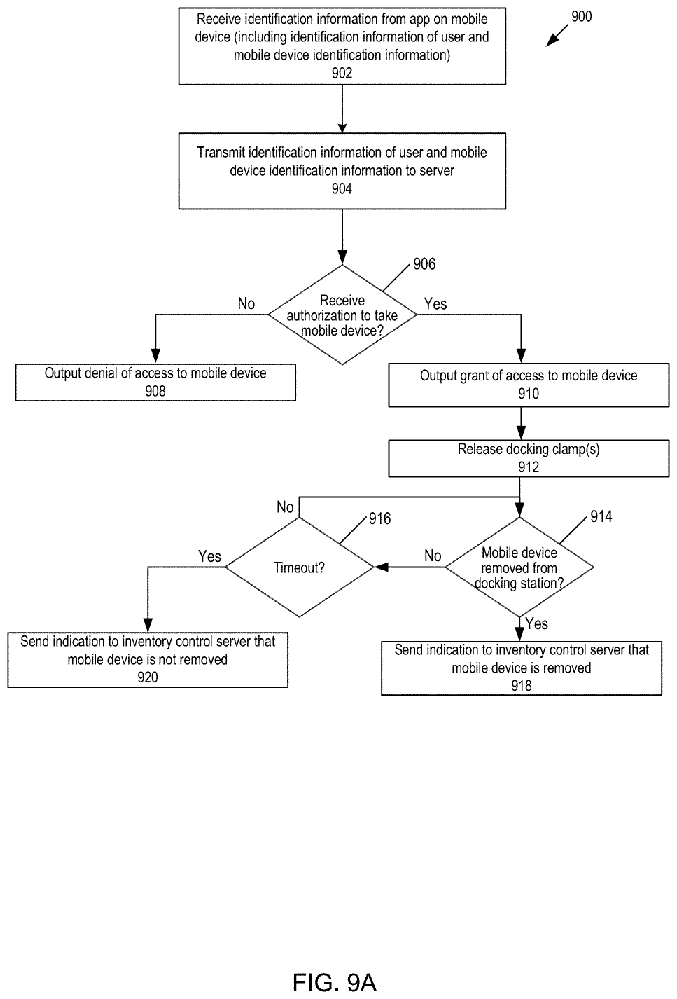

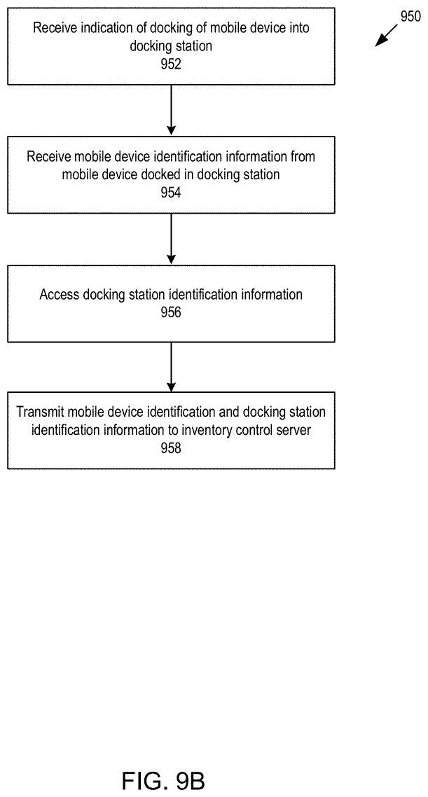

The processor 724 and memory 726 illustrated in FIG. 7 may have greater capability than the processor 134 and memory 136 in FIGS. 1A-B and the processor 166 and memory 168 in 2A-2B since docking station #1 (720) includes additional functionality. Memory 726 includes inventory control software 728, which may comprise functionality such as illustrated in FIGS. 9A-B. Input/output device(s) 172 may comprise any type of input and/or output device, such as a visual output (e.g., a display or an LED light), an aural output (e.g., a speaker) or the like, as discussed above. The docking station may generate an output via input/output device(s) 172 in response to denying and/or granting removal of the mobile device from the docking station, as discussed further below. Further, the docking station may generate an output via input/output device(s) 172 in response to the mobile device being docked into the docking station.

As discussed above, docking clamp 176 may comprise any type of device that locks or restrains a mobile device within the respective docking station. Further, the respective docking station may include a single docking clamp or multiple docking clamps. In practice, the processor 724 may control the docking clamp 176, such as via solenoid 174, to be in one of two states: locked (in which the mobile device is locked or restrained within the docking station so that a user cannot remove the mobile device from the docking station); and unlocked (in which the mobile device is unrestrained within the docking station so that a user can remove the mobile device from the docking station). In this way, the solenoid 174 may change the state of the docking clamp 176. Alternatively, other types of mechanical or electrical devices are contemplated to change the state of docking clamp 176, as discussed above.

Mobile device #1 (750) includes connector 142, processor 134, memory 136, battery 139, input/output device(s) 140, and communication interface 132. As discussed above, connector 142 may be shaped to mechanically connect with connector 162 of docking station #1 (730). Memory 136 may include software, such as inventory app 752. Input/output device(s) 140 may comprise any type of input and/or output device, such as a display (e.g., a touchscreen display), a speaker, a keyboard, or the like. Inventory app 752 may include some of the functionality included in inventory app 138, such as providing an interface to input user identification information. However, unlike inventory app 752, inventory app 138 is configured to interact with the inventory server.

As discussed in further detail below, a user may access inventory app 752 via input/output device(s) 140 in order for the user to input user identification information for submission to docking station #1 (720). In one implementation, the inventory app 752 may automatically activate to output an interface on a screen of mobile device #1 (750) upon wake-up of mobile device #1 (750). Alternatively, the user may activate inventory app 752. After activation, the user may input user identification information. As discussed above, the user identification information may comprise the user's name, the user's credit card information, the user's driver's license number, the user's employee identification number, or other information indicative of or unique to the user.

Similar to FIG. 2A, FIG. 7 may be modified such that the docking station may receive a mobile device in a mobile device case, and may further charge the batteries on both the mobile device and the mobile device case. Further, similar to FIGS. 1B and 2B, a head unit may be configured to control the docking stations such that the processor 724 and memory 726 are not resident on the docking station (or are still resident but at a lower capacity of processing/memory capability). In this way, the head unit may control a set of docking stations. In addition, similar to FIGS. 1B-C and 2B-C, the head unit may communicate with the docking station via a bus or via a serial connection.

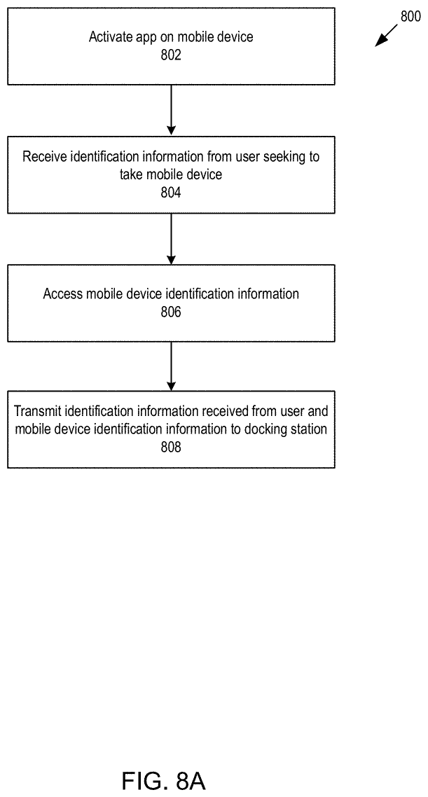

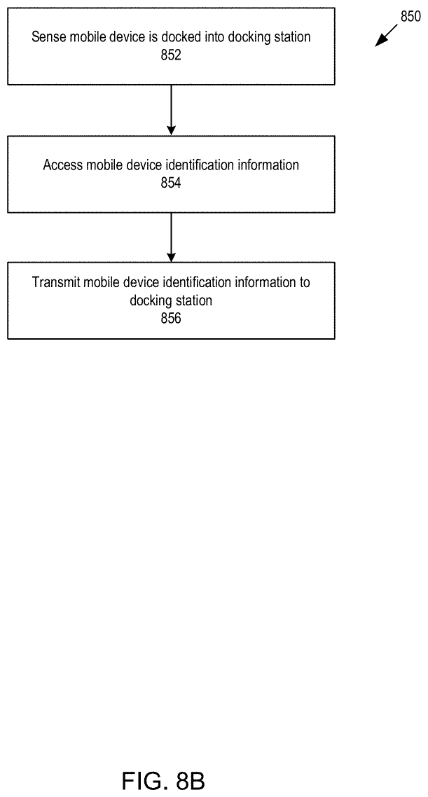

FIG. 8A illustrates a flow diagram 800 for a mobile device to interact with a docking station in order for a user to remove the mobile device from the docking station. At 802, the app is activated on the mobile device. As discussed above, the app may be activated automatically. Alternatively, the app may be activated responsive to input from a user. At 804, the app receives identification information from the user seeking to take the mobile device from the docking station. At 806, the mobile device accesses its own identification information. As discussed above, the mobile device identification information may comprise any identifying information sufficient for the inventory control system to track the use of a respective mobile device. For example, the mobile device identification information may comprise the manufacturer serial number for the mobile device. As another example, the mobile device identification information may be assigned after manufacture, such as part of the inventory control system. At 808, the mobile device transmits to the docking station the identification information received from the user and the mobile device identification information.

FIG. 8B illustrates a flow diagram 850 for a mobile device to interact with a docking station when a user returns the mobile device to the docking station. Similar to FIG. 4B, at 852, the mobile device senses that it is docked into the docking station. For example, the mobile device may sense that its connector, such as connector 142, is interfacing with a connector on the docking station. Responsive to sensing the docking, at 854, the mobile device accesses the mobile device identification information. At 856, the mobile device transmits the mobile device identification information to the docking station. Alternatively, the docking station, responsive to determining that a mobile device has docked therein, may request the mobile device identification information from the mobile device.

FIG. 9A illustrates a flow diagram 900 for a docking station to interact with a mobile device in order for a user to remove the mobile device from the docking station. At 902, the docking station receives identification information from the mobile device. For example, the docking station may receive from an app on the mobile device identification information of the user and mobile device identification information. Responsive to receipt, at 904, the docking station may transmit the identification information of the user and mobile device identification information to the inventory control server. The transmission to the inventory control server may be indicative of a request by the docking station for the inventory control server to authorize removal of the mobile device from the docking station.

At 906, the docking station determines whether the inventory control server sent an authorization allowing the removal of the mobile device from the docking station. If not, at 908, the docking station outputs an indication of denial to access the mobile device. For example, the docking station may output a visual cue (e.g., a red light) and/or auditory cue indicating that the user is denied access. If so, at 910, the docking station may output an indication of allowing access to the mobile device. For example, the docking station may control a green LED to activate on the docking station. At 912, the docking station may further control the docking clamp(s) to be placed in the unlocked or released state so that the user may remove the mobile device from the docking station.

At 914, the docking station determines whether the mobile device has been removed from the docking station. The docking station may determine whether the mobile device has been removed based on the USB interface. If the docking station determines that the mobile device has not been removed, at 916, the docking station determines whether the timeout has occurred. For example, the docking station may wait 1 minute until determining a timeout has occurred. If not, flow diagram 900 loops back to 914. If yes, at 920, the docking station may send an indication to the inventory control server that the mobile device has not been removed. If the docking station determines that the mobile device has been removed from the docking station, at 918, the docking station may send an indication to the inventory control server that the mobile device has been removed.

FIG. 9B illustrates a flow diagram 950 for a docking station to interact with a mobile device when a user returns the mobile device to the docking station. At 952, the docking station may receive an indication that the mobile device has been docked into the docking station. As one example, the docking station may determine, itself, that the mobile device has been docked therein. As another example, the docking station may receive a communication from the mobile device indicating that the mobile device has been docked in the docking station. At 954, the docking station receives the mobile device identification information from the mobile device docking in the docking station. For example, the docking station may send a request to the mobile device to send the mobile device identification information to the docking station. Responsive to the request, the mobile device may send the mobile device identification information to the docking station. As another example, the mobile device, unprompted by the docking station, may send the mobile device identification information to the docking station. At 956, the docking station may further access in its memory, such as memory 726, docking station identification information. As discussed above, docking station identification information may identify the respective docking station within the inventory control system. At 958, the docking station transmits the mobile device identification information and the docking station identification information to the inventory control server.

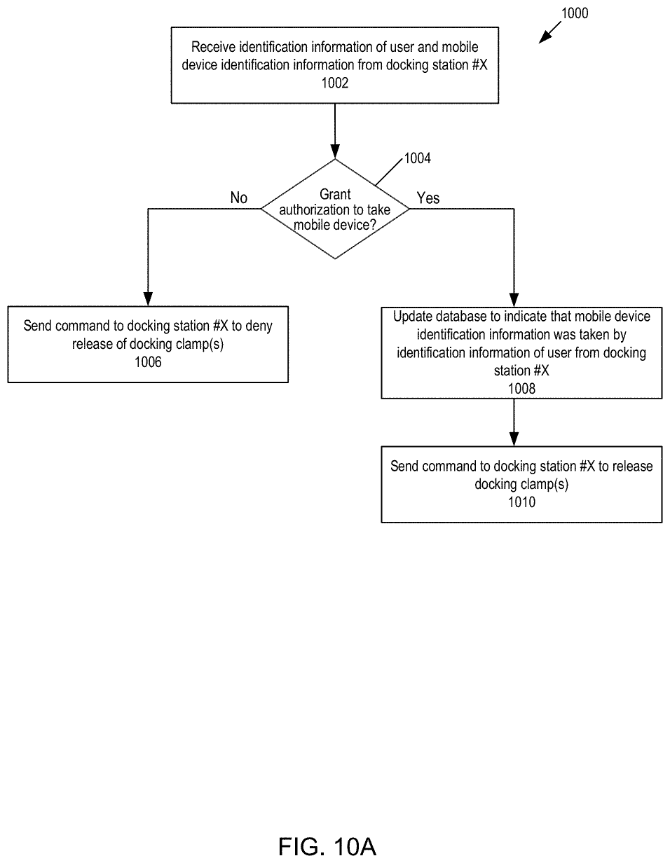

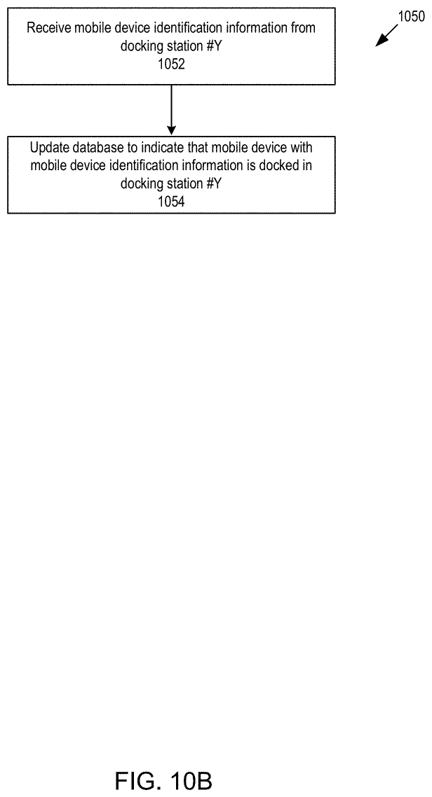

FIG. 10A illustrates a flow diagram 1000 for the inventory control server to interact with a docking station in order for a user to remove a mobile device from the docking station. At 1002, the inventory control server receives identification information of user and mobile device identification information from a docking station, such as docking station #X. At 1004, the inventory control server determines whether to authorize the user to remove the mobile device from the docking station. As one example, the inventory control server may access database 122 to compare the identification information of the user with authorized identification information in the database 122. In response to determining that the identification information of the user matches authorized identification information in the database 122, the inventory control server may authorize the user to remove the mobile device from the docking station. As another example, the inventory control server may access the identification information of the user, such as credit card information, to determine whether the credit card information is authorized by a separate server, such as a credit card processing server. Responsive to the inventory control server receiving authorization to charge the credit card of the user, the inventory control server may authorize the user to remove the mobile device from the docking station.

If authorized, at 1008, the server updates the database (such as database 122) to indicate that the mobile device, identified as mobile device identification information, was taken by user, identified by identification information of user, from docking station #X. Further, at 1010, the inventory control server sends a command indicative of the authorization, such as a command to docking station #X to release docking clamp(s). If not authorized, at 1006, the inventory control server sends a command indicative of denying authorization, such as a command to docking station #X to deny release of docking clamp(s).

FIG. 10B illustrates a flow diagram 1350 for the inventory control server to interact with a docking station when a user returns the mobile device to the docking station. At 1052, the inventory control server receives mobile device identification information from a particular docking station, such as docking station #Y. At 1054, the inventory control server updates the database, such as database 1022, to indicate that the mobile device associated with mobile device identification information is docked in docking station #Y. Alternatively, or in addition, the inventory control server may be configured to automatically generate a report at a predetermined time (e.g., at midnight each day) indicating the mobile devices that have not been returned to the docking station (e.g., a list of mobile devices by the mobile device identification information).

FIG. 11 illustrates a block diagram of exemplary computer system 1100 for the electronic devices of FIGS. 1A-2C and 7. Computer system 1100 thus includes a network interface 1120 that allows communication with other computers via a network 1126, where network 1126 may be represented by network 1120 in FIG. 11. Network 1126 may be any suitable network and may support any appropriate protocol suitable for communication to computer system 1100. In an implementation, network 1126 may support wireless communications. In another implementation, network 1126 may support hard-wired communications, such as a telephone line or cable. In another implementation, network 1126 may support the Ethernet IEEE (Institute of Electrical and Electronics Engineers) 802.3x specification. In another implementation, network 1126 may be the Internet and may support IP (Internet Protocol). In another implementation, network 1126 may be a LAN or a WAN. In another implementation, network 1126 may be a hotspot service provider network. In another implementation, network 1126 may be an intranet. In another implementation, network 1126 may be a GPRS (General Packet Radio Service) network. In another implementation, network 1126 may be any appropriate cellular data network or cell-based radio network technology. In another implementation, network 1126 may be an IEEE 802.11 wireless network. In still another implementation, network 1126 may be any suitable network or combination of networks. Although one network 1126 is shown in FIG. 11, network 1126 may be representative of any number of networks (of the same or different types) that may be utilized.

Generally speaking, logic circuitry, such as a controller, may control various electronic devices discussed herein. Computer system 1100 is one manifestation of the logic circuitry. The controller may include embedded memory and/or interact with external memory, and can take one of several forms, one of which is a processor 1102 and memory (e.g., main memory 1104, a static memory 1106), with other forms including processing circuitry, a microprocessor or processor, and a computer-readable medium that stores computer-readable program code (e.g., software or firmware) executable by the (micro)processor, logic gates, switches, an application specific integrated circuit (ASIC), a programmable logic controller, and an embedded microcontroller, for example. The controller can be configured with hardware and/or firmware to perform the various functions described below and shown in the flow diagrams. Thus, the computer system 1100 may also include a processor 1102, a main memory 1104, a static memory 1106, an output device 1110 (e.g., a display or speaker), an input device 1112, and a storage device 1116, communicating via a bus 1108.

Processor 1102 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 1102 executes instructions 1124 stored on one or more of the main memory 1104, static memory 1106, or storage device 1115. Processor 1102 may also include portions of the computer system 1100 that control the operation of the entire computer system 1100. Processor 1102 may also represent a controller that organizes data and program storage in memory and transfers data and other information between the various parts of the computer system 1100.

Processor 1102 is configured to receive input data and/or user commands through input device 1112. Input device 1112 may be a keyboard, mouse or other pointing device, trackball, scroll, button, touchpad, touch screen, keypad, microphone, speech recognition device, video recognition device, accelerometer, gyroscope, global positioning system (GPS) transceiver, or any other appropriate mechanism for the user to input data to computer system 1100 and control operation of computer system 1100 and/or operation of the inventory control application 1016. Input device 1112 as illustrated in FIG. 11 may be representative of any number and type of input devices.

Processor 1102 may also communicate with other computer systems via network 1126 to receive instructions 1124, where processor 1102 may control the storage of such instructions 1124 into any one or more of the main memory 1104 (e.g., random access memory (RAM)), static memory 1106 (e.g., read only memory (ROM)), or the storage device 1116. Processor 1102 may then read and execute instructions 1124 from any one or more of the main memory 1104, static memory 1106, or storage device 1116. The instructions 1124 may also be stored onto any one or more of the main memory 1104, static memory 1106, or storage device 1116 through other sources. The instructions 1124 may correspond to, for example, instructions for inventory control application 116, inventory app 138, docking station software 170, docking station software 198, inventory control software 728, or inventory app 752 illustrated in FIGS. 1A-2C and 7.

Although computer system 1100 is represented in FIG. 11 as a single processor 1102 and a single bus 1108, the disclosed implementations applies equally to computer systems that may have multiple processors and to computer systems that may have multiple busses with some or all performing different functions in different ways.

Storage device 1116 represents one or more mechanisms for storing data. For example, storage device 1116 may include a computer readable medium 1122 such as read-only memory (ROM), RAM, non-volatile storage media, optical storage media, flash memory devices, and/or other machine-readable media. In other implementations, any appropriate type of storage device may be used. Although only one storage device 1116 is shown, multiple storage devices and multiple types of storage devices may be present. Further, although computer system 1100 is drawn to contain the storage device 1116, it may be distributed across other computer systems that are in communication with computer system 1100, such as a server in communication with computer system 1100.

Storage device 1116 may include a controller (not shown) and a computer readable medium 1122 having instructions 1124 capable of being executed by processor 1102 to carry out functions of the inventory app 138, docking station software 170, 198, temperature regulation 220, inventory control software 728, and/or inventory control software 728. In another implementation, some or all of the functions are carried out via hardware in lieu of a processor-based system. In one implementation, the controller included in storage device 1116 is a web application browser, but in other implementations the controller may be a database system, a file system, an electronic mail system, a media manager, an image manager, or may include any other functions capable of accessing data items. Storage device 1116 may also contain additional software and data (not shown), for implementing described features.

Output device 1110 is configured to present information to the user. For example, output device 1110 may be a display such as a liquid crystal display (LCD), a gas or plasma-based flat-panel display, or a traditional cathode-ray tube (CRT) display or other well-known type of display in the art of computer hardware. Accordingly, in some implementations output device 1110 displays a user interface. In other implementations, output device 1110 may be a speaker configured to output audible information to the user. In still other implementations, any combination of output devices may be represented by the output device 1110.

Network interface 1120 provides the computer system 1100 with connectivity to the network 1126 through any compatible communications protocol. Network interface 1120 sends and/or receives data from the network 1126 via a wireless or wired transceiver 1114. Transceiver 1114 may be a cellular frequency, radio frequency (RF), infrared (IR) or any of a number of known wireless or wired transmission systems capable of communicating with network 1126 or other computer device having some or all of the features of computer system 1100. Bus 1108 may represent one or more busses, e.g., USB, PCI, ISA (Industry Standard Architecture), X-Bus, EISA (Extended Industry Standard Architecture), or any other appropriate bus and/or bridge (also called a bus controller). Network interface 1120 as illustrated in FIG. 11 may be representative of a single network interface card configured to communicate with one or more different data sources.

Computer system 1100 may be implemented using any suitable hardware and/or software, such as a personal computer or other electronic computing device. In addition, computer system 1100 may also be a portable computer, laptop, tablet or notebook computer, PDA, pocket computer, appliance, telephone, server computer device, or mainframe computer.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A mobile device comprising:
an input interface;
a wireless communication interface; and
a controller in communication with the input interface and the wireless communication interface, the controller configured to:
receive, via the input interface, user identification information, the user identification information for identifying a user in a mobile device inventory control system;
transmit, via the wireless communication interface, a request communication to an inventory control server of the mobile device inventory control system, the request communication comprising the user identification information and indicative to the inventory control server a request to remove the mobile device from a docking station;
responsive to transmitting the request, receive from the inventory control server a response;
in response to determining that the response is indicative of allowing removal of the mobile device from the docking station:
send a release command to the docking station, the release command indicative to the docking station to release a locking mechanism on the docking station in order for the user to remove the mobile device from the docking station; and
in response to determining that the response is indicative of disallowing remove of the mobile device from the docking station:
cause an output to be generated, the output indicative of disallowing removal of the mobile device from the docking station.

2. The mobile device of claim 1, further comprising a memory, the memory configured to store mobile device identification information, the mobile device identification information comprising an identification of the mobile device in the mobile device inventory control system; and
wherein the request communication transmitted to the inventory control server further comprises the mobile device identification information, with the request indicative to inventory control server to remove the mobile device associated with the mobile device identification information.

3. The mobile device of claim 1, wherein the controller executes an app to communicate with the inventory control server.

4. The mobile device of claim 1, wherein the controller is further configured to, after sending the release command, determine whether the mobile device was removed from the docking station.

5. The mobile device of claim 4, wherein the controller is further configured to:
responsive to determining that the mobile device was removed from the docking station, send a removed mobile device communication to the inventory control server, the removed mobile device communication indicative to the inventory control server that the mobile device was removed from the docking station; and
responsive to determining that the mobile device was not removed from the docking station, send a failure to remove mobile device communication to the inventory control server, the failure to remove mobile device communication indicative to the inventory control server that the mobile device was not removed from the docking station.

6. The mobile device of claim 5, wherein the controller is configured to determine that the mobile device was not removed from the docking station by determining, after a timeout period, that the mobile device is still mechanically connected to the docking station.

7. The mobile device of claim 1, further comprising a rechargeable battery; and
wherein the rechargeable battery is configured to be recharged from the docking station.

8. The mobile device of claim 1, wherein the controller is further configured to:
sense that the mobile device has been redocked into an available docking station; and
responsive to sensing that the mobile device has been redocked into the available docking station, send a redocked communication to the inventory control server, the redocked communication indicative to the inventory control server that the mobile device has been redocked.

9. The mobile device of claim 8, further comprising a memory, the memory configured to store mobile device identification information, the mobile device identification information comprising an identification of the mobile device in the mobile device inventory control system; and
wherein the controller is further configured to communicate with the available docking station in order to receive docking station identification information; and
wherein the redocked communication comprises the docking station identification information and the mobile device identification information.

10. The mobile device of claim 1, wherein the input interface comprises a display; and
wherein the controller is configured to cause the output to be generated by generating the output on the display.

11. The mobile device of claim 1, wherein the controller is configured to cause the output to be generated by causing the docking station to generate the output.

12. An inventory control server comprising:
a database configured to store inventory data for a plurality of mobile devices;
a communication interface; and
a controller in communication with the database and the communication interface, the controller configured to:
receive a request from a mobile device to be released from a docking station, the request comprising user identification information;
responsive to receiving the request:
determine, based on the user identification information, whether to authorize the mobile device to be released from the docking station;
responsive to determining to authorize the mobile device to be released from the docking station, send an authorize communication to the mobile device, the authorize communication indicative to the mobile device to command the docking station to change a state of the docking station to allow removal of the mobile device from the docking station;
responsive to determining to deny the mobile device to be released from the docking station, send a deny communication to the mobile device, the deny communication indicative to the mobile device to cause an output representative of denying removal of the mobile device from the docking station;
receive a docking request from the mobile device that is docked in an available docking station, the docking request comprising mobile device identification information and available docking station identification information; and
responsive to receiving the docking request, update, based on the mobile device identification information and the available docking station identification information, the database.

13. The inventory control server of claim 12, wherein the controller is further configured to, after sending the authorize communication to the mobile device, receive a removed mobile device communication, the removed mobile device communication indicative that the mobile device was removed from the docking station.

14. The inventory control server of claim 13, wherein the controller is further configured to, responsive to receiving the removed mobile device communication, update the database.

15. The inventory control server of claim 12, wherein the controller is further configured to:
after sending the authorize communication to the mobile device, receive a failure to remove mobile device communication, the failure to remove mobile device communication indicative that the mobile device was not removed from the docking station; and
update the database based on the failure to remove mobile device communication.

16. A docking station comprising:
charging functionality configured to charge a mobile device docked in the docking station;
communication functionality configured to communicate with the mobile device;
a clamp, the clamp controllable in at least a locked state and an unlocked state, in the locked state, the mobile device is locked in the docking station, in the unlocked state, the mobile device is unlocked and removable from the docking station;
a controller in communication with the communication functionality and the clamp, the controller configured to:
communicate via the communication functionality with an app on the mobile device;
receive identification information from the app on the mobile device, the identification information indicative of a person requesting removal of the mobile device from the docking station;
transmit a request to an inventory control server, the request including the identification information and indicative of requesting the inventory control server whether to allow removal of the mobile device from the docking station;
responsive to sending the request, receive a response from the inventory control server;
in response to determining that the response is indicative of allowing the removal of the mobile device from the docking station, control the clamp to change a state of the clamp from the locked state to the unlocked state in order to allow the removal of the mobile device from the docking station; and
in response to determining that the response is indicative of denying the removal of the mobile device from the docking station:
maintain the state of the clamp in the locked state; and
generate an output indicative of denying the removal of the mobile device from the docking station.

17. The docking station of claim 16, wherein the charging functionality is configured to charge a battery on the mobile device via a mechanical connector; and
wherein the communication functionality is configured to communicate with the mobile device via the mechanical connector.

18. The docking station of claim 17, wherein the request further comprises an identification of the mobile device.

19. The docking station of claim 17, further comprising a solenoid; and
wherein the controller is configured to release the clamp by activating the solenoid.

20. The docking station of claim 17, wherein the controller is further configured to:
while the clamp is in the unlocked state, receive an indication that the mobile device is docked into the docking station;
responsive to receiving the indication:
communicate with the mobile device in order to receive a mobile device identification;
transmit a docking request to the inventory control server, the docking request comprising the mobile device identification and indicative to the inventory control server that the mobile device has been docked into the docking station; and
activate the clamp so that the docking station is in the locked state.
